(19) United States
(12) Patent Application Publication
(10) Pub. No.: US 2017/0324988 A1
(43) Pub. Date: Nov. 9, 2017

(54) METHOD AND DEVICE FOR TRANSMITTING CONTENT

(71) Applicant: THOMSON LICENSING, Issy les Moulineaux (FR)

(72) Inventor: Wei FAN, Beijing (CN)

(73) Assignee: THOMSON LICENSING, Issy les Moulineaux (FR)

(21) Appl. No.: 15/533,369

(22) PCT Filed: Dec. 5, 2014
(86) PCT No.: PCT/CN2014/093146

§ 371 Date: Jun. 5, 2017

(51) Int. Cl. H04N 21/431; H04N 21/414; H04L 29/06; H04L 29/08; H04N 21/643; H04N 21/61

(52) U.S. Cl. CPC H04N 21/431; H04N 21/64322; H04N 21/6125; H04L 65/4069; H04L 67/148; H04N 21/41407

(57) ABSTRACT

It provides a method for transmitting content, wherein at an intermediate device, e.g. the gateway, that connects a content server and at least two rendering devices, comprising steps of receiving a request for a content destined to the content server from a first rendering device; establishing a first connection between the first rendering device and the intermediate device and a second connection between the intermediate device and the content server; sending data of the content received via the second convection to the first rendering device via the first connection; receiving a request for the content destined to the content server from a second rendering device; establishing a third connection between the intermediate device and the second rendering device; and using the second connection to receive data of the content and sending the data to the second rendering device via the third connection.

### TECHNICAL FIELD

The present disclosure relates to data processing, and more particularly relating to a method and a device for transmitting content.

### BACKGROUND

Over-the-top content (OTT) refers to delivery of video, audio and other media over the Internet without a multiple system operator being involved in the control or distribution of the content. The Internet service provider (ISP) may be aware of the contents of the Internet Protocol packets but is not responsible for them, nor able to control viewing abilities, copyrights, and other redistribution of the content. This is in contrast to purchase or rental of video or audio content from an Internet service provider, such as pay television video on demand or an IPTV video service, like AT&T U-Verse. OTT in particular refers to content that arrives from a third party, such as NowTV, Netflix, WhereverTV, NetD, Hulu, Crackle, WWE Network, RPI TV or myTV, and is delivered to an end user device, leaving the ISP responsible only for transporting IP packets. With wide use of OTT boxes as well as televisions embedded with functions of OTT box, more and more people would like to watch the online video/movies on TV at home via the OTT boxes instead of on PC, tablet and smartphone. And there is a requirement of users to dynamically switch playback or playing of content from one rendering device to another, e.g. from living room TV to bedroom TV, or from tablet/smartphone to living room TV.

There are some existing technologies to enable to switch the playing content between two devices, including AirPlay, Miracast, DLNA (Digital Living Network Alliance), etc. But in these Internet based online media playing applications, there are some limitations:

1) AirPlay: when intending to switch a being-played content from a client to an AirPlay server e.g. AppleTV, the client sends the content URL and the current playing position in the playing axis of the content to the AppleTV. In response, the AppleTV setups a new connection to a content server by initiating and sending a request with the content URL to the content server and then seeks to the specified playing position. Since the connection to the content server needs to be reestablished, the server regards the connection as a new client request. Thus, the server exerts again some repeated behaviors which have been exerted during the previous playing progress. For example, the AppleTV plays advertisement video clip again; other behaviors includes authentication process. It brings a bad impact to user experience.

2) Miracast: a device that is playing the content works as source device. It encodes local video and sends them to a selected target device via a WiFi-Direct connection. The source device cannot leave or terminate its connection with a content server when it serves the target device with the encoded video.

3) DLNA: it requires a content server to host contents for streaming them. In the scenario of Internet online media playing, it's not possible that the content server in the Internet is a DLNA DMS (Digital Media Server) compatible device.

Therefore, it is desired a method and an apparatus for transmitting media content from a rendering device to another selected rendering device during playback of the media content, without deteriorating viewing experience of users.

### SUMMARY

According to an aspect of the present disclosure, it provides a method for transmitting content, wherein at an intermediate device, e.g. the gateway, that connects a content server and at least two rendering devices, comprising steps of receiving a request for a content destined to the content server from a first rendering device; establishing a first connection between the first rendering device and the intermediate device and a second connection between the intermediate device and the content server; sending data of the content received via the second connection to the first rendering device via the first connection; receiving a request for the content destined to the content server from a second rendering device; establishing a third connection between the intermediate device and the second rendering device; and using the second connection to receive data of the content and sending the data to the second rendering device via the third connection.

According to another aspect of the present disclosure, it provides a device for transmitting content from a content server, wherein the device connects the content server and at least two rendering devices, comprising a transceiver for receiving and sending data; a processor for receiving, via the transceiver, a request for a content destined to the content server from a first rendering device; establishing a first connection between the first rendering device and the device and a second connection between the device and the content server; sending, via the transceiver, data of the content received via the second connection to the first rendering device via the first connection; receiving, via the transceiver, a request for the content destined to the content server from a second rendering device; establishing a third connection between the device and the second rendering device; and using the second connection to receive data of the content and sending the data to the second rendering device via the third connection

It is to be understood that more aspects and advantages of the disclosure will be found in the following detailed description of the present disclosure.

### BRIEF DESCRIPTION OF THE DRAWINGS

The accompanying drawings, which are included to provide a further understanding of the invention and are incorporated in and constitute a part of this application, will be used to illustrate an embodiment of the invention, as explained by the description. The invention is not limited to the embodiment.

In the drawings:

FIG. 1 is a block diagram showing a system for transmitting media or video content according to an embodiment of the present disclosure;

FIG. 2 is a flow chart showing a method for transmitting content according to the embodiment of the present disclosure;

FIG. 3 is a diagram showing TCP connections for carrying content from the content server 101 to the rendering device A 103 according to the embodiment of the present disclosure;

FIG. 4 is a diagram showing part of an on-screen menu according to the embodiment of the present disclosure;

FIG. 5 is a flow chart showing implementation of the method for transmitting content according to the embodiment of the present disclosure; and

FIG. 6 is a diagram showing the connections according to the embodiment of the present disclosure.

### DETAILED DESCRIPTION

The embodiment of the present invention will now be described in detail in conjunction with the drawings. In the following description, some detailed descriptions of known functions and configurations may be omitted for clarity and conciseness.

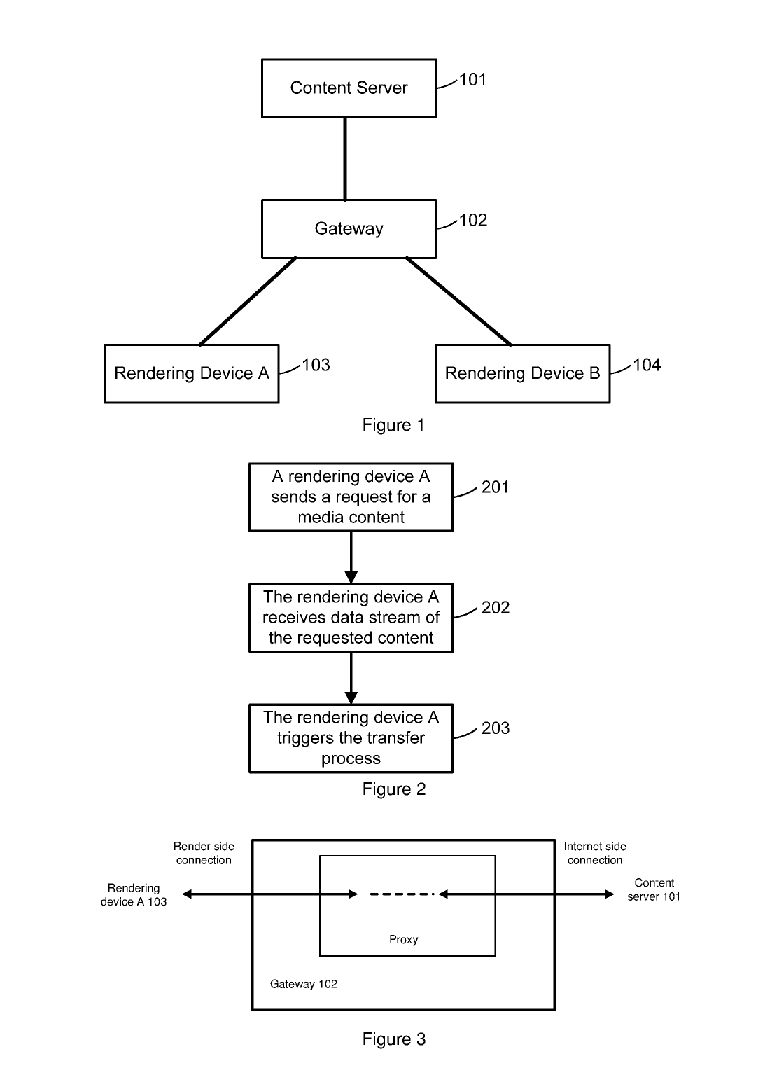

FIG. 1 is a block diagram showing a system for transmitting media or video content according to an embodiment of the present disclosure. The system comprises a content server 101, a gateway 102 and two or rendering devices 103 and 104 (the diagram only shows 2 rendering devices).

The content server 101 provides media content, e.g. video or audio in data packets to one or more rendering devices via the gateway 102. The content server 101, in one example, is a server in the Internet.

The gateway 102 is an intermediate device between the content server 101 and rendering devices. In one example, it is at user end, e.g. in user home and is a router. In order to achieve the purpose of the present disclosure, a proxy function needs to be supported or implemented in the gateway 102. The gateway 102 needs to be able to automatically recognize transfer protocol or transfer messages, and then apply the application proxy for the protocol/message to establish the connection between render devices and the content server 101. Typically, since many content servers on the Internet use HTTP protocol to transfer the video/audio content to end user at home, so the application proxy is a HTTP proxy in the context of Internet.

The rendering devices 103 and 104 are used for sending a request for a media content, e.g. a video or an audio, to the content server 101, requesting transfer of data session and receiving media content from the content server 101 and displaying it. They are in one of the following forms including: Internet TV, TV with Internet Set Top Box, tablet, PC and laptop etc.

In the prior art, if a user wants to transfer data session of the media content between rendering devices, i.e. to watch the content on the rendering device B while he is watching it on the rendering device A, a new connection between the rendering device B and the content server is established and the connection between the rendering device A is terminated. But the content server regards the connection to the rendering device B as a new connection because it needs to allocate a new network socket address, which is the combination of an IP address and a port number in the Internet Protocol.

But in the present embodiment, two TCP connections are established between the two end points of a rendering device and the content server 101, i.e. one TCP connection between the rendering device and the gateway and the other TCP connection between the gateway 102 and the content server 101. Herein, it shall note that we can also use UDP connections. When transferring data session of the media stream carrying the media content from the rendering device A 103 to the rendering device B 104, the TCP connection between the gateway 102 and the server 101 remain unchanged, a new TCP connection between the rendering device B 104 and the gateway 102 is set up and the TCP connection between the rendering device A 103 and the gateway 102 is de-established. The gateway 102 forwards data packets of the data session for the requested media content to the rendering device B 104 other than the device A. “forward” herein means that for the received data packets, the gateway does not change payload data, but changes source device's IP address and port number and destination device's IP address and port number corresponding to the connection between the gateway and the rendering device B. In addition, the rendering device A 103 sends its current playing context to the rendering device B 104 so that the rendering device B 104 has a same context for playing the media content.

FIG. 2 is a flow chart showing a method for transmitting content according to the embodiment of the present disclosure.

In the step 201, a rendering device A 103 sends a request for a selected content to the content server 101. The request includes URL of the selected content. When the rendering device A sends the request for a media content to the content server 101 via the gateway 102, two TCP connections are established, separately between the content server 101 and the gateway 102 and between the gateway 102 and the rendering device A. FIG. 3 is a diagram showing TCP connections for carrying content from the content server 101 to the rendering device A 103. During the establishment of connections, the gateway 102 records connection proxy data locally (in memory or a local storage), for example, the data used to identify the two connections. In one example, it stores the following information:

A. render device's IP address and port number: they in combination uniquely correspond to a media rendering/playing application running in the rendering device;

B. gateway's IP address and port number for connecting with the render application in the rendering device;

C. gateway's IP address and port number for connecting with the content server; and

D. URL (uniform resource locator) of the requested media content. A person skilled in the art shall note that location indicator that uniquely identifies the location of the requested media content can be used, such as absolute path (or relative path) plus file name of the requested media content.

In the step 202, the rendering device A 103 receives data stream of the requested content in the form the data packets from the content server 101 via the gateway 102.

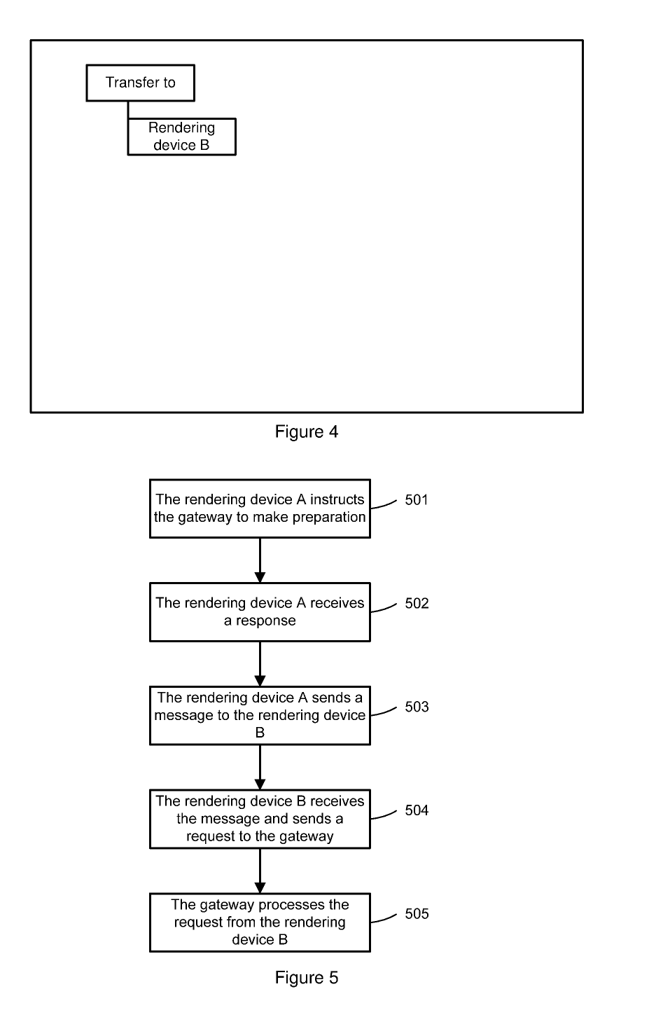

In the step 203, when a user wants to transfer the data stream from the rendering device A 103 to the rendering device B 104, he can select the rendering device B 104 as destination device from on-screen menu on the rendering device A. The rendering device A triggers the process for transferring the data stream from the rendering device A to the rendering device B. FIG. 4 is a diagram showing part of an on-screen menu according to the embodiment of the present disclosure. As can be seen from the FIG. 4, there is sub-menu “rendering device B” under the menu “transfer to”. The user can use a remote controller or a mouse to select sub-menu “rendering device B”. It shall note that if there are more rendering devices available for content transfer, these rendering devices are listed under the menu “transfer to”. It shall also note that the sub-menu can be manually configured (including IP address) or automatically implemented. As to the automatic implementation, it can be realized by using UPnP (universal plug and play). Upon selection of the rendering device B 104, the rendering device A 103 sends instructions to the gateway and the rendering device B separately. FIG. 5 is a flow chart showing implementation of the method for transmitting content according to the embodiment of the present disclosure.

In the step 501, the rendering device A sends message to gateway to instruct the gateway to make preparation for the content transfer. The message comprises

A. IP address and port number of the current rendering device, i.e. the rendering device A;

B. URL of the requested media content; and

C. IP address of a targeting rendering device, i.e. rendering device B;

At the side of the gateway, it receives this switching message from the rendering device A, and prepares itself to wait to process a request to this URL from the rendering device B. Specifically, the gateway generates one pre-check item with the rendering device B's IP address and the URL. After the preparation is finished, the gateway sends a response message indicating that preparation is finished to rendering device A.

In the step 502, the rendering device A receives a response message indicating that preparation is finished from the gateway.

In the step 503, the rendering device A sends a message to the rendering device B in order to make the rendering device B continue playing the requested content. The message is used to instruct the rendering device B to transfer the data session to it. And the message comprises:

A. One or more rendering context parameters e.g. playing progress (time point), status (e.g. pause or play), volume, media format (e.g. FLV, MOV, HTML5 etc), session information (e.g. the cookie and session ID of the current active HTTP media content transmission session, and relevant server and client side description information applied in the session, and the media playing status e.g. position and volume), authentication information if any (e.g. the password, token or certificate used to talk with the media server and decrypt the media content) etc. This information can let the rendering device B to initialize the context for the render application in the rendering device B to continue the play of the requested content from the position indicated by the playing progress parameter. In an example, the rendering context parameter only includes playing progress indicating the current playing position when the rendering device A receives the instruction to transfer the data stream from the rendering device A to the rendering device B.

B. The URL, which tells the rendering device B to use it to retrieve the media content for play.

In the step 504, the rendering device B receives the message from the rendering device A. Upon the reception of the message, the rendering device B sends a request including the URL to the content server.

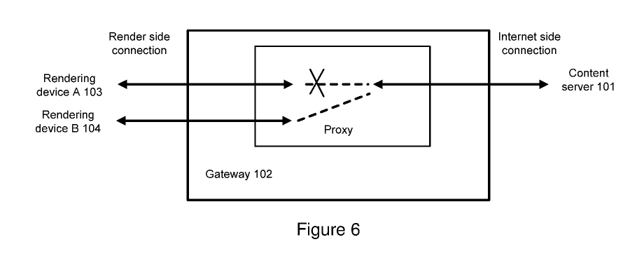

In the step 505, the gateway receives the request from the rendering device B, and determines if it matches the generated pre-check item. Specifically, it checks if the packet comes from the IP address included in the pre-check item (i.e. the rendering device B's IP address) and if the URL in the request is the same as URL included in the pre-check item. If the result is negative, the gateway establishes a new Internet side connection to the content server for the URL and sends the request to the content server over the connection. Herein the connection can be used later for conveying the media content. In another example, the gateway does not establish the connection, but sends the request. If the content server accepts the request, the connection is established for conveying the media content. If the result is positive, the gateway terminates or discards the request and applies the application proxy to firstly setup the render side connection to the rendering device B, which is typically a TCP connection. Herein, in other words, after the rendering device B sends the request to the content server, it establishes a connection to the gateway. Meanwhile, gateway application proxy sets up the Internet side connection for this URL request from the rendering device B. Instead of creating a new Internet side connection between the gateway and the content server for this specific requested content, the gateway uses the existing Internet side connection of the URL previously for the rendering device A. Specifically, after the establishment of the connection between the rendering device B and the gateway, the rendering device B initializes the rendering context of the rendering device B. As to the initialization of the rendering context, it comprises actions of adjusting volume, seeking to the playing position as indicated by the playing progress parameter etc. Specifically, during the initialization, the rendering device B reuses the context parameters received from the original rendering device A, e.g. session information, security and authentication information, applies them into the “new” session to be established from the rendering device B, and reuses the authentication information when interacting with the content server and decrypts the media data. When the rendering device B sends a request message to the content server to seek playing position when the content playing is switched, the request message is sent to the content server via the connection between the rendering device B and the gateway and the connection between the gateway and the content server. The content server receives the request message regarding as if the request message comes from the original rendering device A and sends the requested content from that playing point to the rendering device B. Herein, the data packets sent from the rendering device B to the content server are sent through this existing Internet side connection to the content server by the application proxy. And the data packets of the requested content sent from the content server are sent to the rendering device B instead of the rendering device A. Moreover, after establishment of the connection between the rendering device B and the gateway, the gateway tears down or releases the previous render side connection to the rendering device A, for example by using the stored IP address and port number of the rendering device A. FIG. 6 is a diagram showing the connections according to the embodiment of the present disclosure.

For Internet content server, the play switching/transfer process is transparent to it. The content server is not aware that the home side rendering device changes because the connection sockets for the request content is still the same (IP address and port number) on the side of the content server and on the side of the gateway.

Thus, the Internet content playing is smoothly and continuously switched from the rendering device A to the rendering device B.

A person skilled in the art shall know that the content is not limited to media content. The content shall include data of on-line game etc.

Below shows an application of the present invention.

1. A user selects an Internet movie, and clicks to play it on the rendering device A. The initial 30 seconds before the movie content is embedded with advertisement that can't be skipped.

2. After watching for a while e.g. 20 minutes, the user decides to switch the play progress to rendering device B in living room. Of course, he won't to re-wait the 30 seconds of the initial embedded advertisement.

3. The user, at rendering device A, selects the found render B as the switching target, and clicks the switching button.

4. The Internet movie is continuously played on the rendering device B from the point when the playing is switched, without introducing re-playing of the initial embedded advertisement.

This present embodiment proposes a new solution to support the requirement of play progress dynamically switching for Internet based video between render devices. Meanwhile, the solution not only allows the user to switch the Internet content playing from one device to another, but also lets the user not e.g. be forced to re-watch the inserted advertisement before the movie started, or has to keep the original playing device still alive as encoding and transferring source.

Below introduces a modified embodiment of the present disclosure.

It provides a method for transmitting content, wherein at an intermediate device, e.g. the gateway, that connects a content server and at least two rendering devices, comprising steps of receiving a request for a content destined to the content server from a first rendering device, wherein the request includes a location indicator for the content; establishing a first connection between the first rendering device and the intermediate device and a second connection between the intermediate device and the content server; sending data of the content received via the second connection to the first rendering device via the first connection; receiving a request for the content destined to the content server from a second rendering device, wherein the request includes the location indicator for the content; establishing a third connection between the intermediate device and the second rendering device; and using the second connection to receive data of the content and sending the data to the second rendering device via the third connection.

In addition, as an improvement, before the step of receiving the request from the second rendering device the method further comprises steps of receiving a message from the first rendering device, wherein the message includes the location indicator and a targeting rendering device indicator; wherein before the step of establishing the third connection the method further comprises steps of determining if the request from the second rendering device matches the location indicator and the IP address of the targeting rendering device included in the message; if determination result is positive, proceeding to the step of establishing the third connection and the steps of keeping using and sending.

In addition, as an improvement, the method further comprises a step of if determination result is negative, sending the request from the second rendering device to the content server.

In addition, as an improvement, the step of determining further comprises a step of determining if the second rendering device that sends the request is the same as that indicated by the targeting rendering device indicator and determining if the location indicator in the request is the same as the location indicator included in the message sent by the first rendering device.

In addition, as an improvement, the method further comprises a step of after establishing the third connection releasing the first connection between the first rendering device and the intermediate device.

In addition, as an improvement, the message sent by the first rendering device further includes IP address and port number of the first rendering device corresponding to the first connection, the step of releasing further comprises using the IP address and the port number of the first rendering device to release the first connection.

It also provides a computer program product downloadable from a communication network and/or recorded on a medium readable by computer and/or executable by a processor, comprising program code instructions for implementing above method steps.

It also provides a non-transitory computer-readable medium comprising a computer program product recorded thereon and capable of being run by a processor, including program code instructions for implementing above method steps.

It also provides a device for transmitting content from a content server, wherein the device connects the content server and at least two rendering devices, comprising a transceiver for receiving and sending data; a processor for receiving, via the transceiver, a request for a content destined to the content server from a first rendering device, wherein the request includes a location indicator for the content; establishing a first connection between the first rendering device and the device and a second connection between the device and the content server; sending, via the transceiver, data of the content received via the second connection to the first rendering device via the first connection; receiving, via the transceiver, a request for the content destined to the content server from a second rendering device, wherein the request includes the location indicator for the content; establishing a third connection between the device and the second rendering device; and using the second connection to receive data of the content and sending the data to the second rendering device via the third connection. Herein, the transceiver is hardware implemented, e.g. wired network interface (e.g. RJ45) or wireless network interface (e.g. Wi-Fi).

In addition, as an improvement, the processor is further used for before receiving the request from the second rendering device receiving, via the transceiver, a message from the first rendering device, wherein the message includes the location indicator and a targeting rendering device indicator; and before establishing the third connection determining if the request from the second rendering device matches the location indicator and the IP address of the targeting rendering device included in the message; and if determination result is positive, proceeding to the step of establishing the third connection and the steps of keeping using and sending.

In addition, as an improvement, the processor is further used for if determination result is negative, sending the request from the second rendering device to the content server.

In addition, as an improvement, the processor is further used for determining if the second rendering device that sends the request is the same as that indicated by the targeting rendering device indicator and determining if the location indicator in the request is the same as the location indicator included in the message sent by the first rendering device.

In addition, as an improvement, the processor is further used for after establishing the third connection releasing the first connection between the first rendering device and the device.

In addition, as an improvement, wherein the message sent by the first rendering device further includes IP address and port number of the first rendering device corresponding to the first connection, and the processor is further used for using the IP address and the port number of the first rendering device to release the first connection.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the invention as defined by the appended claims.

1. A method for transmitting content, at an intermediate device that connects to a content server and at least two rendering devices, comprising
receiving a request for a content, which comprises an identifier of the content and is destined to the content server, from a first rendering device;
establishing a first connection between the first rendering device and the intermediate device and a second connection between the intermediate device and the content server;
sending data of the content received via the second connection to the first rendering device via the first connection;
receiving a message comprising the identifier of the content and a target rendering device indicator indicating a target rendering device from the first rendering device;
receiving a request comprising an identifier destined to the content server from a second rendering device; and
upon determining that the identifier in the request from the second rendering device is the same as the identifier of the content in the message received from the first rendering device and the second rendering device is the same as the target rendering device in the message received from the first rendering device, establishing a third connection between the intermediate device and the second rendering device and using the second connection to receive data of the content and sending the data to the second rendering device via the third connection.

2. The method of the claim 1, wherein
the identifier of the content is a location indicator for the content.

3. The method of the claim 1, wherein further comprising
upon determining that the identifier in the request from the second rendering device and the second rendering device are not the same as the identifier of the content and the target rendering device in the message received from the first rendering device, sending the request from the second rendering device to the content server.

4. The method of the claim 2, wherein further comprising
determining if the second rendering device that sends the request is the same as that indicated by the target rendering device indicator and determining if the location indicator in the request is the same as the location indicator included in the message sent by the first rendering device.

5. The method of the claim 1, wherein after establishing the third connection further comprising
releasing the first connection between the first rendering device and the intermediate device.

6. The method of the claim 5, wherein the message sent by the first rendering device further includes IP address and port number of the first rendering device corresponding to the first connection, the step of releasing further comprising
using the IP address and the port number of the first rendering device to release the first connection.

7. A device for transmitting content from a content server, wherein the device connects to the content server and at least two rendering devices, comprising
a transceiver for receiving and sending data;
a processor for receiving, via the transceiver, a request for a content, which comprises an identifier of the content and is destined to the content server, from a first rendering device; establishing a first connection between the first rendering device and the device and a second connection between the device and the content server; sending, via the transceiver, data of the content received via the second connection to the first rendering device via the first connection; receiving, via the transceiver, a message comprising the identifier of the content and a target rendering device indicator indicating a target rendering device from the first rendering device; receiving, via the transceiver, a request comprising an identifier destined to the content server from a second rendering device; and upon determining that the identifier in the request from the second rendering device is the same as the identifier of the content in the message received from the first rendering device and the second rendering device is the same as the target rendering device in the message received from the first rendering device, establishing a third connection between the device and the second rendering device and using the second connection to receive data of the content and sending the data to the second rendering device via the third connection.

8. The device of the claim 7, wherein the identifier of the content is a location indicator for a content.

9. The device of the claim 7, wherein
the processor is further used for, upon determining that the identifier in the request from the second rendering device and the second rendering device are not the same as the identifier of the content and the target rendering device in the message received from the first rendering device, sending the request from the second rendering device to the content server.

10. The device of the claim 8, wherein
the processor is further used for determining if the second rendering device that sends the request is the same as that indicated by the target rendering device indicator and determining if the location indicator in the request is the same as the location indicator included in the message sent by the first rendering device.

11. The device of the claim 7, wherein
the processor is further used for, after establishing the third connection, releasing the first connection between the first rendering device and the device.

12. The device of the claim 11, wherein the message sent by the first rendering device further includes IP address and port number of the first rendering device corresponding to the first connection, and
the processor is further used for using the IP address and the port number of the first rendering device to release the first connection.

13. Computer program comprising program code instructions executable by a processor for implementing a method according to claim 1.

14. Computer program product which is stored on a non-transitory computer readable medium and comprises program code instructions executable by a processor for implementing a method according to claim 1.
